(19) United States
(12) Patent Application Publication
(10) Pub. No.: US 2025/0341645 A1
(43) Pub. Date: Nov. 6, 2025

(54) SELF-SUPERVISED VELOCITY MODEL BUILDING WITH UPHOLES AND REFRACTION TRAVEL TIME DATA

(71) Applicant: Saudi Arabian Oil Company, Dhahran (SA)

(72) Inventors: Daniele Colombo, Dhahran (SA); Ersan Turkoglu, Dhahran (SA); Ernesto Sandoval Curiel, Dhahran (SA)

(21) Appl. No.: 18/652,407

(22) Filed: May 1, 2024

(51) Int. Cl. G01V 1/28; G01V 1/30; G01V 1/34; G06N 20/00

(52) U.S. Cl. CPC G01V 1/282; G01V 1/303; G01V 1/345; G06N 20/00

(57) ABSTRACT

The construction of an uphole-calibrated velocity model from uphole seismic survey data using a machine learning model. Uphole seismic survey data may be processed to obtain seismic travel times sorted in a midpoint-offset domain. The machine learning model may be trained with pairs of training data that include travel time vs offset and uphole time, travel times vs offset and uphole velocity, and travel times vs. offset and seismic velocity determined from an interval velocity interpretation of uphole times. The trained machine learning model may output calibrated pseudo uphole velocities having a vertical resolution comparable to the existing upholes.

### BACKGROUND

### Field of the Disclosure

The present disclosure generally relates to geophysical exploration using seismic surveying. More specifically, embodiments of the disclosure relate to constructing a velocity model from uphole surveys.

### Description of the Related Art

In geophysical exploration, such as the exploration for hydrocarbons, seismic surveys are performed to produce images of the various rock formations in the earth (“subsurface”) or underwater (“subsea”). The seismic surveys obtain seismic data indicating the response of the rock formations to the travel of elastic wave seismic energy. The resulting seismic data is processed and analyzed to yield information relating to produce seismic images of the formations and their locations in an area of interest beneath the earth's surface. However, various features and layers of the earth may make accurate imaging and interpretation of subsurface reservoirs difficult.

### SUMMARY

Oil and gas seismic exploration on land prospects may suffer from complex physical parameter distributions occurring in the undersaturated shallow layer of the near surface (that is, the “weathering” layer). In arid regions the weathering is typically deep and extend up to hundreds of meters. This undersaturated layer is problematic as the relatively low velocities associated with it are difficult to infer with conventional seismic acquisition that is tuned to target deep subsurface reservoirs. If the low velocity weathering layer is not correctly mapped and the associated velocities are not correctly reconstructed, large distortions are introduced in the propagation of the deep reflected seismic waves, resulting in poor imaging or distorted geometrical imaging of the deep structures related to the prospects. These distorted subsurface images increase the risk of drilling a dry well.

Because of these problems, specific investigations may be performed for the shallow near surface by means of what is known as “uphole surveys.” In an uphole survey, a source is lowered within a shallow borehole (for example, 100-500 meters depth) and the uphole times are recorded by seismic receivers (for example, geophones) located on the surface in proximity of the borehole. For example, FIGS. 1A and 1B depict a schematic of an uphole survey in accordance with an embodiment of the disclosure. FIG. 1A depicts a schematic of borehole lithology with different layers depicted vs depth of the borehole 100. FIG. 1B depicts an arrangement of an uphole survey with seismic source array 102 and a receiver 104. FIGS. 1C and 1D depicts results from an uphole survey in accordance with an embodiment of the disclosure. FIG. 1C depicts an example uphole time-depth record 106 (travel time vs. depth), and FIG. 1D depicts an interpreted interval velocity vs depth (line 108) based on the example uphole time-depth record.

The vertical travel times are interpreted for the interval velocities and a detailed velocity profile is obtained for describing the velocity structure of the weathering layer and of the investigated near surface below the weathering layer. However, propagating this localized velocity calibration to the rest of the model—which is obtained from conventional seismic acquisition and may extend for several hundred or thousand square kilometers—is challenging.

Uphole surveys are typically sparse and in best case scenarios are relatively densely spaced along lines (for example, several hundred meters) with large intervals (for example, several kilometers) in the crossline direction. This spatial configuration makes interpolation (for example, Kriging algorithm, inverse distance weighted IDW interpolation, minimum curvature algorithm, and the like) difficult, as the aspect ratio of vertical sampling (along the uphole), and of horizontal sampling (among different sparse uphole locations) is suboptimal.

Another difficulty in spatial interpolation/extrapolation of uphole data in a regular grid is related to the vertical sampling that is typically of the scale of meters for upholes and of several tens of meters for 3D meshes. Interpolating finely sampled vertical velocity vectors over large horizontal distances typically introduce so called “bull eyes”-localized circular velocity features at the location of the borehole with the space in between the boreholes overly smooth. Such velocity models are unusable for any seismic data processing; in some instances, a large smoothing (or spatial averaging/regularization) is applied, but this approach invalidates any possible benefit obtained from a localized, high-resolution velocity calibration. Consequently, the integration of uphole data with seismic first arrival travel time data (for example, first breaks) from conventional surveys remains difficult, such that the seismic processor is faced with the option of using uphole data or switching to first breaks for deriving the near surface velocity model.

Embodiments of the disclosure are directed to use of a machine learning (ML) model and seismic travel time data to perform such uphole-calibrated velocity model building over vast exploration areas and obtain robust near surface velocities for resource exploration. Embodiments of the disclosure include the use of uphole data as labels to seismic travel times that may be sorted in a midpoint-offset domain. The machine learning model may be trained in a self-supervised fashion and then applied to a full dataset to provide a calibrated high-resolution velocity model for the weathering section.

In one embodiment, a method for determining uphole velocities of an uphole velocity model for an uphole seismic survey having an uphole seismic survey dataset generated from a seismic receiver station configured to sense seismic signals originating from a seismic source station is provided. The method includes obtaining the uphole seismic survey dataset having first break travel times, sorting the first break travel times into offset bins of a travel time attribute cube according to common midpoints for refracted seismic wave travel between the seismic sources and the seismic receiver, and removing anomalous travel times from the sorted travel times in the offset bins to form a refined first break dataset. The method also includes forming a travel times vs offset function based on the refined first break dataset, obtaining uphole times associated with the uphole seismic survey dataset, the uphole times including travel times vs depth, and training a supervised machine learning model using training data that includes the travel times vs offset function at a common midpoint (CMP) based on an uphole location, and the uphole times at the uphole location, such that the uphole times are the labels for the training data. The method further includes determining uphole times for the entire uphole seismic survey dataset using the trained machine learning model and transforming the determined uphole times to uphole velocities.

In some embodiments, the supervised machine learning model is a fully-connected artificial neural network (ANN), a convolutional neural network (CNN) or a multivariate regression model. In some embodiments, the method includes generating a seismic image using the uphole velocities.

In another embodiment, a non-transitory computer-readable storage medium having executable code stored thereon for determining uphole velocities of an uphole velocity model for an uphole seismic survey having an uphole seismic survey dataset generated from a seismic receiver station configured to sense seismic signals originating from a seismic source station. The executable code includes a set of instructions that causes a processor to perform operations that include obtaining the uphole seismic survey dataset having first break travel times, sorting the first break travel times into offset bins of a travel time attribute cube according to common midpoints for refracted seismic wave travel between the seismic sources and the seismic receiver, and removing anomalous travel times from the sorted travel times in the offset bins to form a refined first break dataset. The operations also include forming a travel times vs offset function based on the refined first break dataset, obtaining uphole times associated with the uphole seismic survey dataset, the uphole times including travel times vs depth, and training a supervised machine learning model using training data that includes the travel times vs offset function at a common midpoint (CMP) based on an uphole location, and the uphole times at the uphole location, such that the uphole times are the labels for the training data. The operations further include determining uphole times for the entire uphole seismic survey dataset using the trained machine learning model and transforming the determined uphole times to uphole velocities.

In some embodiments, the supervised machine learning model is a fully-connected artificial neural network (ANN), a convolutional neural network (CNN) or a multivariate regression model. In some embodiments, the operations include generating a seismic image using the uphole velocities.

In another embodiment, a system is provided that includes a seismic source station, a seismic receiver station configured to sense seismic signals originating from a seismic source station, a seismic data processor, and a non-transitory computer-readable storage memory accessible by the seismic data processor and having executable code stored thereon for determining uphole velocities of an uphole velocity model for an uphole seismic survey having an uphole seismic survey dataset from the seismic signals. The executable code has a set of instructions that causes the seismic data processor to perform operations that include obtaining the uphole seismic survey dataset including first break travel times, sorting the first break travel times into offset bins of a travel time attribute cube according to common midpoints for refracted seismic wave travel between the seismic sources and the seismic receiver, and removing anomalous travel times from the sorted travel times in the offset bins to form a refined first break dataset. The operations also include forming a travel times vs offset function based on the refined first break dataset, obtaining uphole times associated with the uphole seismic survey dataset, the uphole times including travel times vs depth, and training a supervised machine learning model using training data that includes the travel times vs offset function at a common midpoint (CMP) based on an uphole location, and the uphole times at the uphole location, such that the uphole times are the labels for the training data. The operations further include determining uphole times for the entire uphole seismic survey dataset using the trained machine learning model and transforming the determined uphole times to uphole velocities.

In some embodiments, the supervised machine learning model is a fully-connected artificial neural network (ANN), a convolutional neural network (CNN) or a multivariate regression model. In some embodiments, the operations include generating a seismic image using the uphole velocities.

In another embodiment, a computer-implemented method for determining uphole velocities of an uphole velocity model for an uphole seismic survey that includes an uphole seismic survey dataset generated from a seismic receiver station configured to sense seismic signals originating from a seismic source station is provided. The method includes obtaining the uphole seismic survey dataset having first break travel times, sorting the first break travel times into offset bins of a travel time attribute cube according to common midpoints for refracted seismic wave travel between the seismic sources and the seismic receiver, and removing anomalous travel times from the sorted travel times in the offset bins to form a refined first break dataset. The method also includes forming a travel times vs offset function based on the refined first break dataset and obtaining uphole velocities associated with the uphole seismic survey dataset, the uphole velocities including interval velocity vs. depth. The method further includes training a supervised machine learning model using training data having the travel times vs offset function at a common midpoint (CMP) based on an uphole location and uphole velocities at the uphole location, such that the uphole velocities are the labels for the training data, and determining uphole velocities for the uphole seismic survey dataset using the trained machine learning model.

In some embodiments, the supervised machine learning model is a fully-connected artificial neural network (ANN), a convolutional neural network (CNN) or a multivariate regression model. In some embodiments, the method includes generating a seismic image using the uphole velocities.

In another embodiment, a non-transitory computer-readable storage medium having executable code stored thereon for determining uphole velocities of an uphole velocity model for an uphole seismic survey having an uphole seismic survey dataset generated from a seismic receiver station configured to sense seismic signals originating from a seismic source station. The executable code has a set of instructions that causes a processor to perform operations that include obtaining the uphole seismic survey dataset having first break travel times, sorting the first break travel times into offset bins of a travel time attribute cube according to common midpoints for refracted seismic wave travel between the seismic sources and the seismic receiver, and removing anomalous travel times from the sorted travel times in the offset bins to form a refined first break dataset. The operations also include forming a travel times vs offset function based on the refined first break dataset and obtaining uphole velocities associated with the uphole seismic survey dataset, the uphole velocities including interval velocity vs. depth. The operations further include training a supervised machine learning model using training data having the travel times vs offset function at a common midpoint (CMP) based on an uphole location and uphole velocities at the uphole location, such that the uphole velocities are the labels for the training data, and determining uphole velocities for the uphole seismic survey dataset using the trained machine learning model.

In some embodiments, the supervised machine learning model is a fully-connected artificial neural network (ANN), a convolutional neural network (CNN) or a multivariate regression model. In some embodiments, the operations include generating a seismic image using the uphole velocities.

In another embodiment, a system is provided that includes a seismic source station, a seismic receiver station configured to sense seismic signals originating from a seismic source station, a seismic data processor, and a non-transitory computer-readable storage memory accessible by the seismic data processor and having executable code stored thereon for determining uphole velocities of an uphole velocity model for an uphole seismic survey having an uphole seismic survey dataset from the seismic signals. The executable code has a set of instructions that causes the seismic data processor to perform operations that include obtaining the uphole seismic survey dataset having first break travel times, sorting the first break travel times into offset bins of a travel time attribute cube according to common midpoints for refracted seismic wave travel between the seismic sources and the seismic receiver, and removing anomalous travel times from the sorted travel times in the offset bins to form a refined first break dataset. The operations also include forming a travel times vs offset function based on the refined first break dataset and obtaining uphole velocities associated with the uphole seismic survey dataset, the uphole velocities including interval velocity vs. depth. The operations further include training a supervised machine learning model using training data having the travel times vs offset function at a common midpoint (CMP) based on an uphole location and uphole velocities at the uphole location, such that the uphole velocities are the labels for the training data, and determining uphole velocities for the uphole seismic survey dataset using the trained machine learning model.

In some embodiments, the supervised machine learning model is a fully-connected artificial neural network (ANN), a convolutional neural network (CNN) or a multivariate regression model. In some embodiments, the operations include generating a seismic image using the uphole velocities.

In another embodiment, a computer-implemented method for determining uphole velocities of an uphole velocity model for an uphole seismic survey having an uphole seismic survey dataset generated from a seismic receiver station configured to sense seismic signals originating from a seismic source station is provided. The method includes obtaining the uphole seismic survey dataset having first break travel times, sorting the first break travel times into offset bins of a travel time attribute cube according to common midpoints for refracted seismic wave travel between the seismic sources and the seismic receiver, and removing anomalous travel times from the sorted travel times in the offset bins to form a refined first break dataset. The method also includes forming a travel times vs offset function based on the refined first break dataset, inverting the travel-times vs offset function to obtain a velocity model for first break waves, such that the velocity model includes seismic velocities vs. depth, and obtaining uphole velocities associated with the uphole seismic survey dataset, the uphole velocities including interval velocity vs. depth. The method further includes training a supervised machine learning model using training data having the seismic velocities vs. depth at an uphole location and the uphole velocities at the uphole location, such that the uphole velocities are the labels for the training data, and determining uphole velocities for the uphole seismic survey dataset using the trained machine learning model.

In some embodiments, the supervised machine learning model is a fully-connected artificial neural network (ANN), a convolutional neural network (CNN) or a multivariate regression model. In some embodiments, the method includes generating a seismic image using the uphole velocities.

In another embodiment, a non-transitory computer-readable storage medium having executable code stored thereon for determining uphole velocities of an uphole velocity model for an uphole seismic survey having an uphole seismic survey dataset generated from a seismic receiver station configured to sense seismic signals originating from a seismic source station. The executable code has a set of instructions that causes a processor to perform operations that include obtaining the uphole seismic survey dataset having first break travel times, sorting the first break travel times into offset bins of a travel time attribute cube according to common midpoints for refracted seismic wave travel between the seismic sources and the seismic receiver, and removing anomalous travel times from the sorted travel times in the offset bins to form a refined first break dataset. The operations also include forming a travel times vs offset function based on the refined first break dataset, inverting the travel-times vs offset function to obtain a velocity model for first break waves, such that the velocity model includes seismic velocities vs. depth, and obtaining uphole velocities associated with the uphole seismic survey dataset, the uphole velocities including interval velocity vs. depth. The operations further include training a supervised machine learning model using training data having the seismic velocities vs. depth at an uphole location and the uphole velocities at the uphole location, such that the uphole velocities are the labels for the training data, and determining uphole velocities for the uphole seismic survey dataset using the trained machine learning model.

In some embodiments, the supervised machine learning model is a fully-connected artificial neural network (ANN), a convolutional neural network (CNN) or a multivariate regression model. In some embodiments, the operations include generating a seismic image using the uphole velocities.

In another embodiment, a system is provided that includes a seismic source station, a seismic receiver station configured to sense seismic signals originating from a seismic source station, a seismic data processor, and a non-transitory computer-readable storage memory accessible by the seismic data processor and having executable code stored thereon for determining uphole velocities of an uphole velocity model for an uphole seismic survey having an uphole seismic survey dataset from the seismic signals. The executable code has a set of instructions that causes the seismic data processor to perform operations that include obtaining the uphole seismic survey dataset having first break travel times, sorting the first break travel times into offset bins of a travel time attribute cube according to common midpoints for refracted seismic wave travel between the seismic sources and the seismic receiver, and removing anomalous travel times from the sorted travel times in the offset bins to form a refined first break dataset. The operations also include forming a travel times vs offset function based on the refined first break dataset, inverting the travel-times vs offset function to obtain a velocity model for first break waves, such that the velocity model includes seismic velocities vs. depth, and obtaining uphole velocities associated with the uphole seismic survey dataset, the uphole velocities including interval velocity vs. depth. The operations further include training a supervised machine learning model using training data having the seismic velocities vs. depth at an uphole location and the uphole velocities at the uphole location, such that the uphole velocities are the labels for the training data, and determining uphole velocities for the uphole seismic survey dataset using the trained machine learning model.

In some embodiments, the supervised machine learning model is a fully-connected artificial neural network (ANN), a convolutional neural network (CNN) or a multivariate regression model. In some embodiments, the operations include generating a seismic image using the uphole velocities.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B depict a schematic of an uphole survey in accordance with an embodiment of the disclosure;

FIGS. 1C and 1D depicts results from an uphole survey as illustrated by FIGS. 1A and 1B in accordance with an embodiment of the disclosure;

FIGS. 2A and 2B depict a process for constructing an uphole-calibrated velocity model from uphole seismic survey data using a machine learning model in accordance with an embodiment of the disclosure;

FIG. 3A depicts an example of a shot gather 300 in accordance with an embodiment of the disclosure;

FIG. 3B depicts a hypercube sorting the picked travel times in midpoint (CMP) offset (XYO) domain in accordance with an embodiment of the disclosure;

FIG. 3C depicts a plot of mean travel time vs offset for a XY-CMP in accordance with an embodiment of the disclosure;

FIG. 3D depicts a vertical velocity profile at the XY-CMP position resulting from the inversion of the travel times versus offset shown in FIG. 3C in accordance with an embodiment of the disclosure;

FIGS. 4A-4F depict example where the uphole times of different velocity models were contaminated by random noise before performing the interval velocity interpretation in accordance an embodiment of the disclosure;

FIGS. 5A-5H depict plots of training pairs of randomly selected travel time vs. offset curves and uphole velocity (that is, from a velocity-depth function) at the same X-Y locations showing correlations between the travel time measurements and uphole velocities in accordance with an embodiment of the disclosure;

FIG. 6 depicts a system for constructing an uphole-calibrated velocity model from uphole seismic survey data using a machine learning model;

FIG. 7 depicts components of a seismic data processing computer in accordance with an embodiment of the disclosure;

FIGS. 8A and 8B depict velocity (in m/s) depth slices approximately 40 meters (m) from the surface for an example dataset in accordance with an embodiment of the disclosure; and

FIGS. 9A and 9B depict E-W velocity (in m/s) cross sections through the entire volume of the example dataset in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure include the construction of an uphole-calibrated velocity model from uphole seismic survey data using a machine learning model. Uphole seismic survey data may be processed to obtain seismic travel times sorted in a midpoint-offset domain. The machine learning model may be trained with pairs of training data that include travel time vs offset and uphole time, travel times vs offset and uphole velocity, and travel times vs. offset and seismic velocity (determined from an interval velocity interpretation of uphole times). The trained machine learning model may output calibrated pseudo uphole velocities having a vertical resolution comparable to the existing upholes.

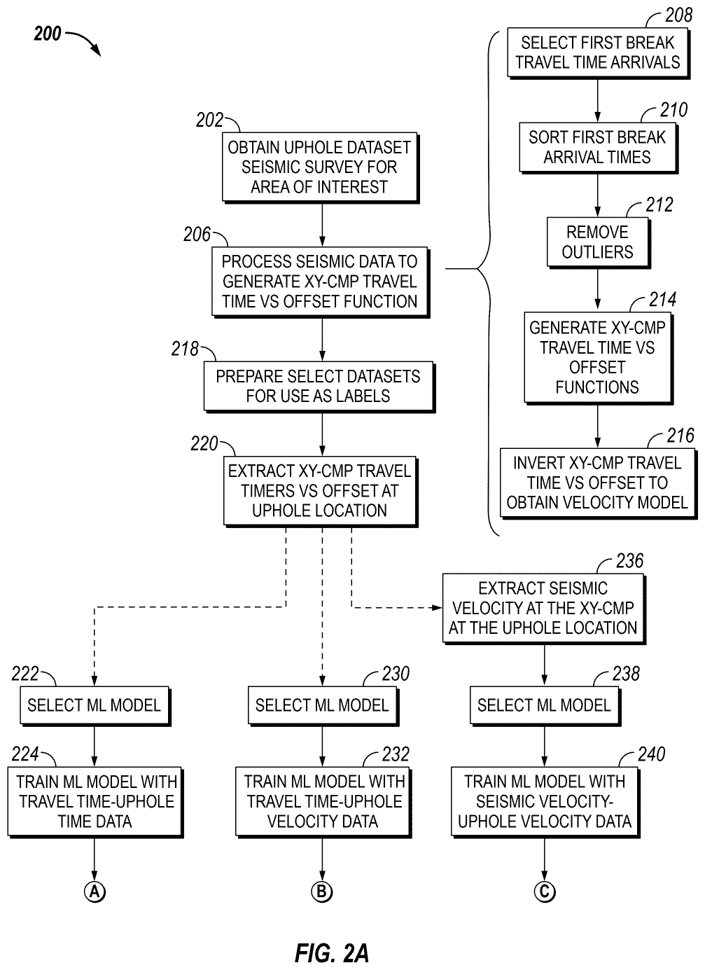

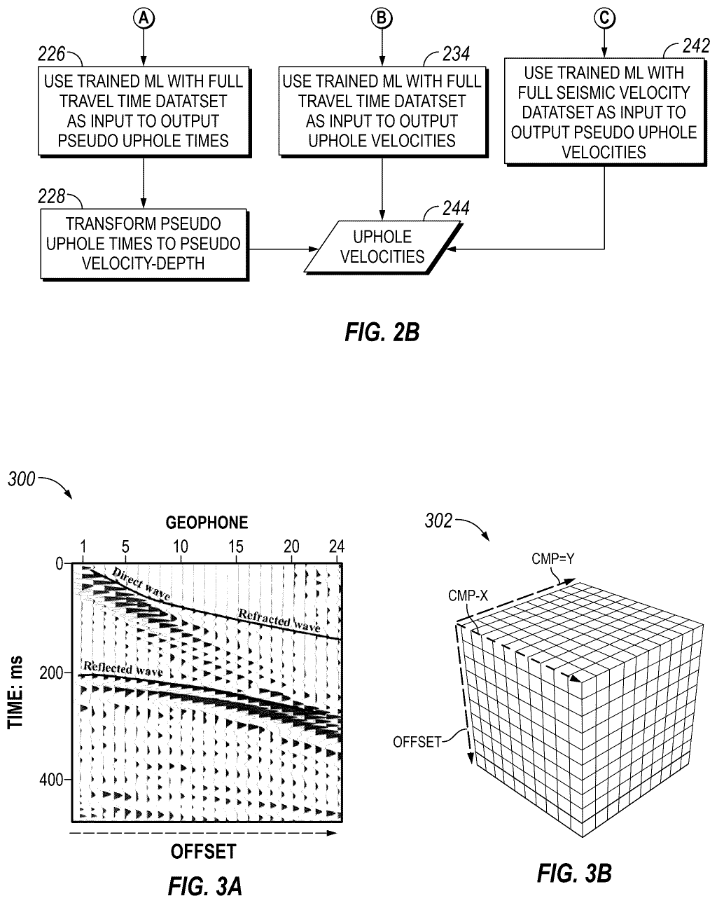

FIGS. 2A and 2B depict a process 200 for constructing an uphole-calibrated velocity model from uphole seismic survey data using a machine learning model in accordance with an embodiment of the disclosure. Initially, an uphole dataset that includes seismic data is obtained for an area of interest (block 202). As known the art, the seismic data may include 3D seismic exploration data.

Next, the seismic data is preprocessed to generate XY-CMP travel time vs offset functions (block 206). For example, the preprocessing may include first break picking, sorting, statistical analysis, and outlier removal. Such preprocessing may include the additional steps depicted in FIG. 2A and discussed infra. It should be appreciated that although the process 200 is described with reference to the generated XY-CMP travel time vs offset function, other embodiments may use general seismic shot gathers instead in the remaining steps of the process 200.

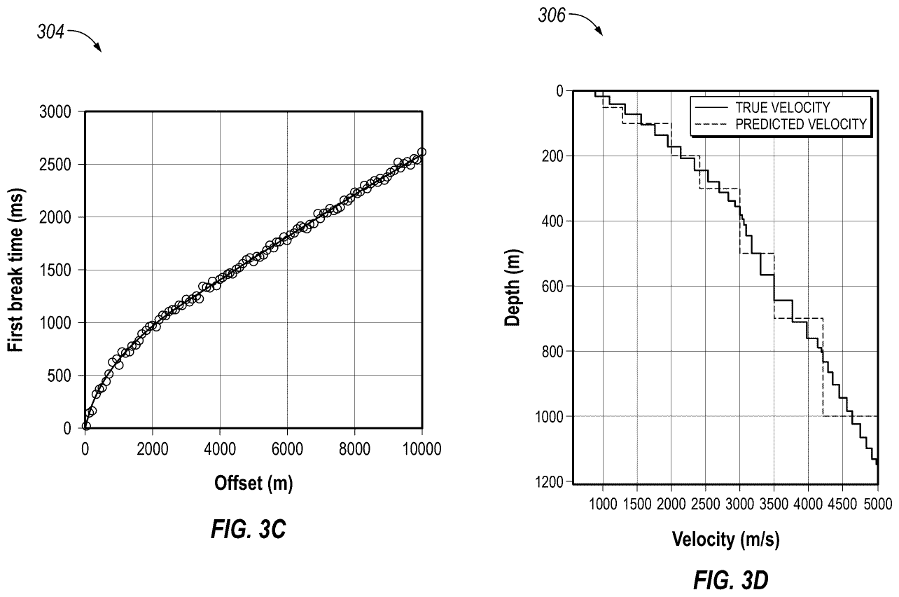

As will be appreciated, the obtained seismic data includes travel times of first arrival waves (known as “first breaks” or “FB”) that correspond to a combination of direct waves and refracted waves, and uphole travel time data. First break travel time arrivals may be selected (block 208) with automatic algorithms on shot gathers for acquisition geometries that can be two-dimensional (2D) and three-dimensional (3D). FIG. 3A depicts an example of a shot gather 300 selected according to this approach.

The first breaks may be then sorted (block 210). The longer the source-receiver offset, the deeper the refracted wave (also called a diving wave) has traveled inside the earth before being recorded by the receiver. Because of this property, the offset dimension may be used as a “pseudo depth” measure in the collection (i.e., sorting) of travel times. Such sorting is also organized for midpoint (also known as “common midpoint” or “CMP”) between source and receiver, such that the sorting domain becomes CMP-X, CMP-Y, Offset or “XYO.” By way of example, FIG. 3B depicts a hypercube 302 sorting the picked travel times in midpoint (CMP) offset (XYO) domain in accordance with an embodiment of the disclosure.

The preprocessing may include removing outliers (block 212). Additionally, the sorting discussed supra may include defining “bins” in spatial X-Y coordinates and the offset domain. Each XYO voxel becomes the collector of FIRST BREAK travel times. In each voxel the collected travel times are analyzed to determine a statistical measure of “mean,” “median,” or other statistical quantity that may be defined for the removal of outliers (for example, FIRST BREAK travel times greater than a certain standard deviation).

Next, XY-CMP travel times vs. offset functions may be generated (block 214). The statistical travel time values versus offset (for example, a vertical column of the hypercube 302 depicted in FIG. 3B) may be graphed to obtain first-break (mean/median) travel time versus offset that represents the volumetric kinematic behavior of the recorded waves around the specified XY-CMP. By way of example, FIG. 3C depicts a plot 304 of mean travel time vs offset for a XY-CMP in accordance with an embodiment of the disclosure.

In some embodiments, travel times versus offset may be inverted or transformed to obtain a velocity model (block 216) through which the refracted waves have traveled. This process returns a one-dimensional (1D) profile of velocity versus depth that resembles the true velocity model in a synthetic simulation. By way of example, FIG. 3D depicts a vertical velocity profile 306 at the XY-CMP position resulting from the inversion of the travel times versus offset shown in FIG. 3C. In some embodiments, this inversion or transformation may be performed according to the techniques described in U.S. Pat. No. 10,386,519, issued Aug. 20, 2019, and titled “AUTOMATED NEAR SURFACE ANALYSIS BY SURFACE-CONSISTENT REFRACTION METHODS,” a copy of which is incorporated by reference in its entirety.

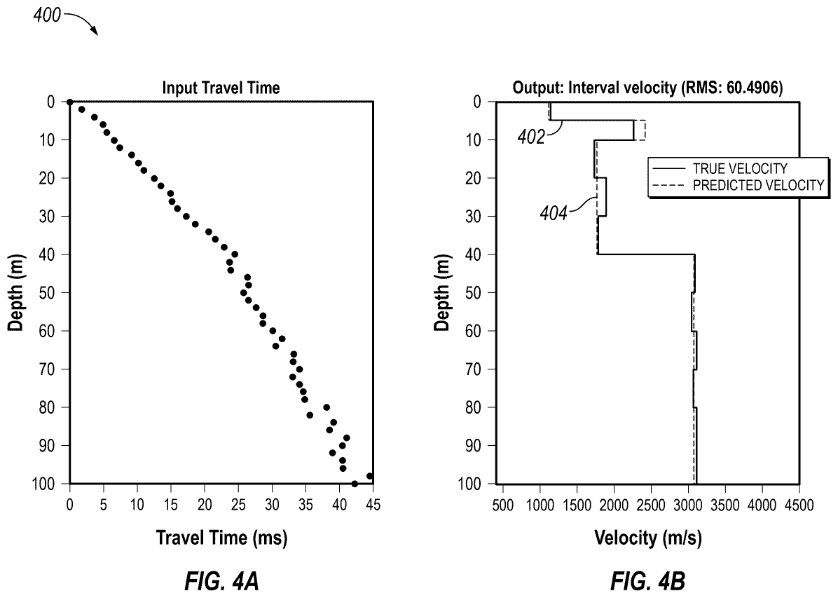

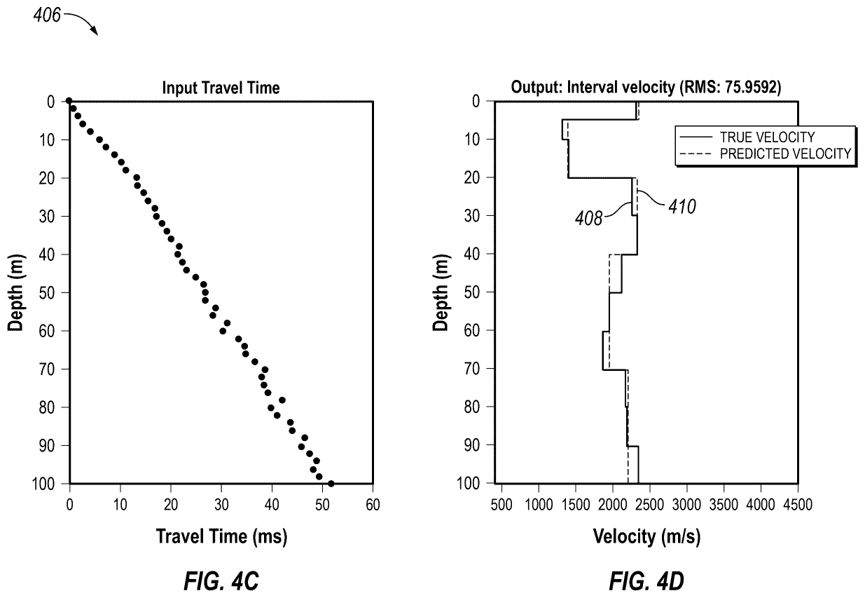

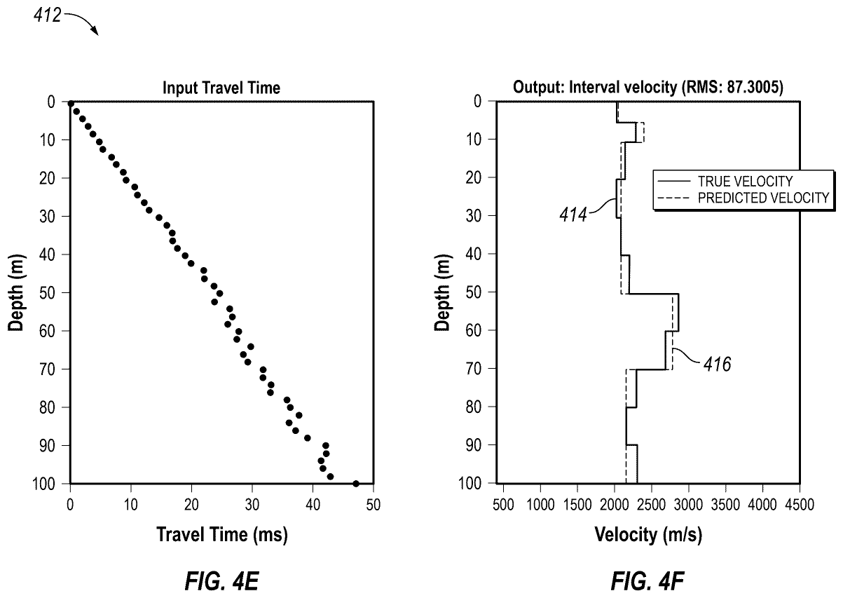

Additional, one or more select datasets may be prepared for use in labeling in a machine learning model (block 218). A selected dataset may be homogenized, filtered, and uniformly sampled for preparation for use as labels in training the machine learning model. As discussed in the disclosure, such datasets may include at least one of uphole times, uphole velocity, and seismic velocity. For the use of uphole times and uphole velocity, the uphole times (that is, uphole vertical path travel times) may be interpreted in terms of interval velocities via the use of standard techniques. FIGS. 4A-4F depict example where the uphole times of different velocity models were contaminated by random noise before performing the interval velocity interpretation in accordance an embodiment of the disclosure. For example, FIG. 4A depicts a plot 400 of synthetic travel time (in milliseconds (ms)) vs. depth (in meters (m), and FIG. 4B depicts a corresponding graph of an interval velocity model 402 (with velocity in m/s) vs. depth (in m) based on the travel times of FIG. 4A, with the true velocity model 404 shown for comparison. In another example, FIG. 4C depicts a plot 406 of synthetic travel time (in ms) vs. depth (in m), and FIG. 4D depicts a corresponding graph of an interval velocity model 408 (with velocity in m/s) vs. depth (in m) based on the travel times of FIG. 4C, with the true velocity model 410 shown for comparison. Finally, FIG. 4E depicts another example plot 412 of synthetic travel time (in ms) vs. depth (in m), and FIG. 4F depicts a corresponding graph of an interval velocity model 414 (with velocity in m/s) vs. depth (in m) based on the travel times of FIG. 4E, with the true velocity model 416 shown for comparison.

The vertical travel time vector or velocity profile from first break first travel times may then be associated with the uphole travel time vector or vertical velocity profile at the same XY-CMP location. This uphole data (uphole time or uphole velocity) may then be used as a label in the supervised machine learning model where the input data is the vertical vectors of first break travel times or velocity profiles from seismic surveys (features). The uphole time refers to as the time-depth functions of FIGS. 4A-4E. The uphole velocity refers to the interval velocity versus depth functions of FIGS. 4B-4F. In another example, seismic velocity refers to the velocity-depth functions depicted in FIG. 3D. FIG. 2B depicts additional these examples of the process 200 in accordance with an embodiment of the disclosure. Each branch in FIG. 2B depicts different three non-limiting training pairs of data, although in other embodiments other combinations may be used.

In some embodiments, the travel time vs. uphole time may be used to train a machine learning model. In such embodiments, the XY-CMP travel times vs offset for a CMP consistent with the uphole location are selected (block 220). A machine learning model may be selected (block 222). In some embodiments, the selected machine learning model may be a fully-connected artificial neural network (ANN), a convolutional neural network (CNN) or a multivariate regression model (for example, using Gaussian Process (GP) regression). In other embodiments, other suitable ML models may be selected.

The machine learning model may be trained with a training set of the travel time-uphole time pair, with the uphole times as the labels for the model (block 224). As will be appreciated, training may include hyperparameter searching and an optimization sequency of training, validation, and testing. In such embodiments, the training set may be divided into subsets for such training, validation, and testing (for example, 15%-15%-70%).

The trained ML model may then receive the full XY-CMP travel times vs offset dataset as input to determine “pseudo” uphole times over the entire travel times dataset (block 226). The uphole times may then be transformed to velocity-depth (block 228) using any suitable technique (inversion, slope/intercept, etc.).

In another embodiment, the travel time vs. uphole velocity may be used to train the machine learning model. In such embodiments, the XY-CMP travel times vs offset for CMP consistent with the uphole location are selected. (block 220) The velocity-depth function (uphole velocity) from the uphole interpretation discussed supra is also used.

A machine learning model may then be selected (block 230). Here again, the selected machine learning model may be a fully-connected artificial neural network (ANN), a convolutional neural networks (CNN) or a multivariate regression algorithm (for example, Gaussian Process (GP) regression). In other embodiments, other suitable ML models may be selected.

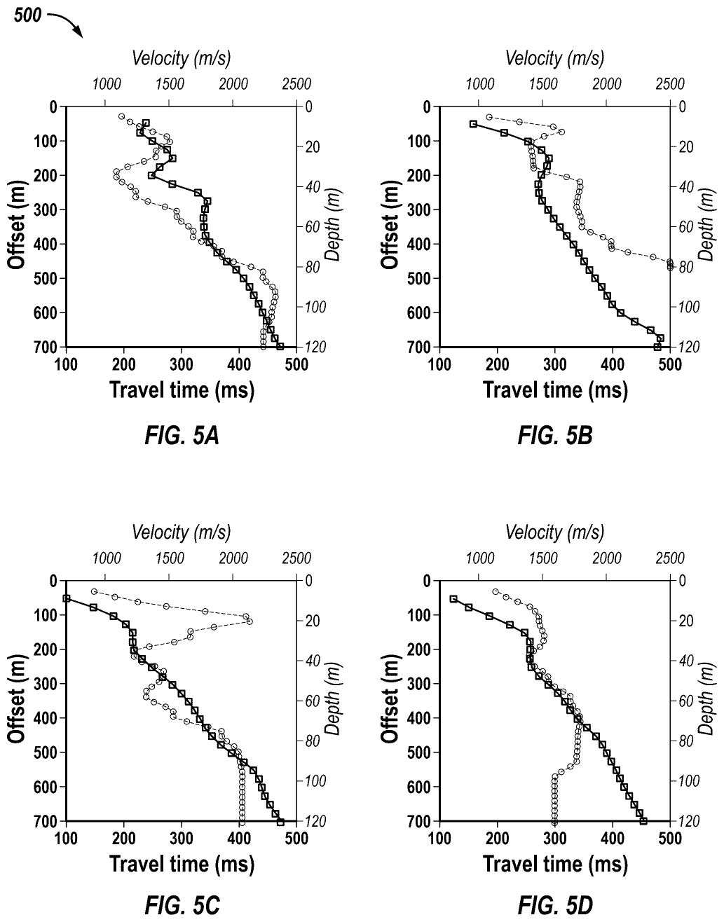

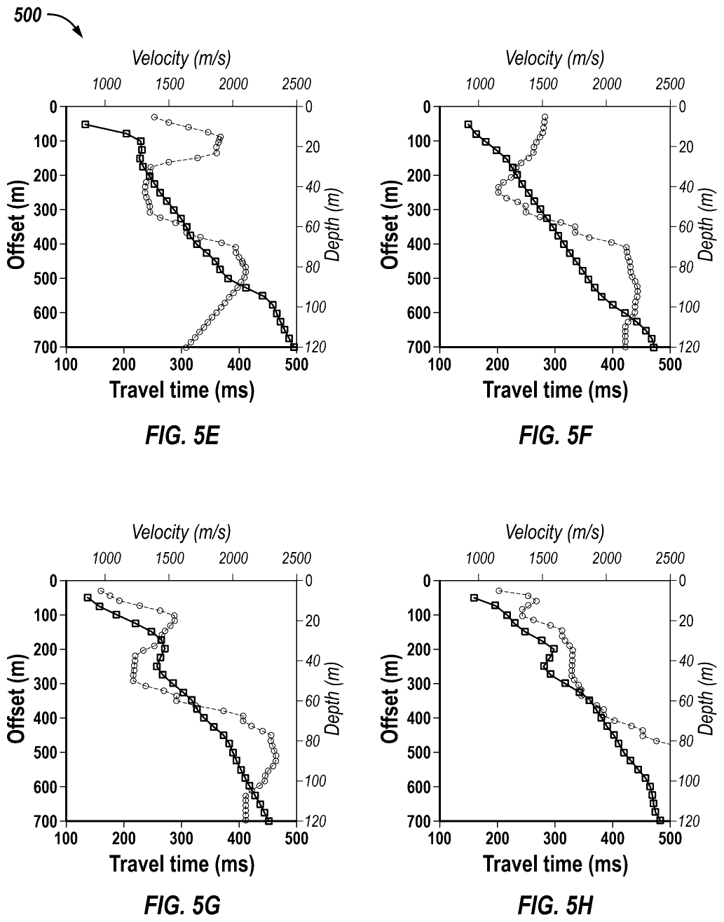

The machine learning model may be trained with a training set of the travel time-uphole velocity pair, with the uphole velocity as the labels for the model (block 232). For example, FIGS. 5A-5H depict plots 500 of training pairs of randomly selected travel time vs. offset curves 502 and uphole velocity 504 (that is, from a velocity-depth function) at the same X-Y locations showing correlations between the travel time measurements and uphole velocities in accordance with an embodiment of the disclosure.

As will be appreciated, training may include hyperparameter searching and an optimization sequency of training, validation, and testing. In such embodiments, the training set may be divided into subsets for such training, validation, and testing (for example, 15%-15%-70%). The trained ML model may then receive the full XY-CMP travel times vs offset dataset as input to determine “pseudo” uphole velocity over the entire travel times dataset (block 234).

In another embodiment, the seismic velocity vs uphole velocity may be used to train the model. In such embodiments, the seismic velocity at the XY-CMP consistent with the uphole location is selected and the uphole velocity from the uphole interpretation discussed supra are selected (block 236). A machine learning model may then be selected (block 238). Here again, the selected machine learning model may be a fully-connected artificial neural network (ANN), a convolutional neural networks (CNN) or a multivariate regression algorithm (for example, Gaussian Process (GP) regression). In other embodiments, other suitable ML models may be selected.

The machine learning model may be trained with a training set of the seismic velocity-uphole velocity pair, with the uphole velocity as the labels for the model (block 240). As with other embodiments, training may include hyperparameter searching and an optimization sequency of training, validation, and testing. In such embodiments, the training set may be divided into subsets for such training, validation, and testing (for example, 15%-15%-70%). The trained ML model may then receive the full seismic velocity dataset as input to determine “pseudo” uphole velocities over the entire travel times dataset (block 242).

Each of the above embodiments may provide “pseudo” uphole velocities (block 244) for the entire uphole dataset that are calibrated through the uphole training and contain a vertical resolution comparable to the existing upholes. The calibrated uphole velocities may be used to generate a seismic image from the uphole seismic survey data that avoids distortions in the images present in prior art techniques. The improve seismic image thus enables more accurate locating of subsurface hydrocarbon-bearing reservoirs and drilling wells to access such reservoirs.

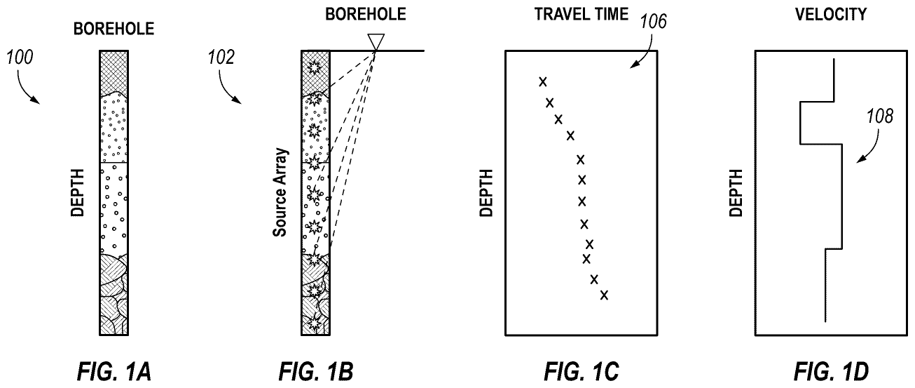

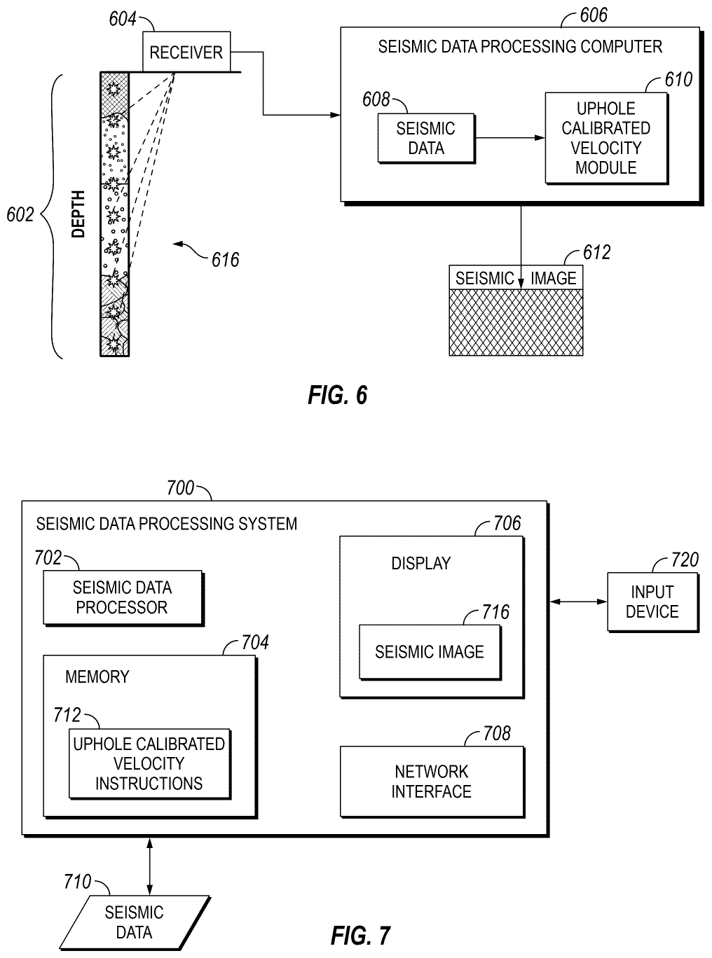

FIG. 6 depicts a system 600 for constructing an uphole-calibrated velocity model from uphole seismic survey data using a machine learning model. The system 600 can include, for example, a seismic source array 602 (also referred to as a “seismic station” array), one or more seismic receivers 604 (also referred to as “receiver stations”) arranged in the manner illustrated in FIG. 1B and discussed supra. The seismic receivers 604 may also be represented by a fiber optic cable for distributed acoustic sensing (DAS). It should be noted that placing receivers in the borehole and sources on the surface has exactly the same effect as travel times and wave propagation follow the principle of reciprocity. The system 600 may also include a seismic data processing computer 606 that stores and processes uphole seismic survey data 608, such as a shot gather responsive to seismic energy signals received by the seismic receiver, and uphole-calibrated velocity module 610 that constructs an uphole-calibrated velocity model from the uphole seismic survey data 608. Additionally, the seismic data processing computer 606 may produce a seismic image 612 from seismic data as is known in the art. According to various embodiments of the present disclosure, the seismic source array 602 can include any seismic or acoustic energy whether from an explosive, implosive, swept-frequency or random sources. The seismic source, for example, can generate a seismic energy signal that propagates into the earth 616.

Generally, the seismic source array 602 can emit seismic waves into the earth 616 to evaluate subsurface conditions and to detect possible concentrations of oil, gas, and other subsurface minerals. Seismic waves may travel through an elastic body (such as the earth 616). The propagation velocity of seismic waves may depend on the particular elastic medium through which the waves travel, particularly the density and elasticity of the medium as is known and understood by those skilled in the art. The refraction or reflection of seismic waves onto the one or more seismic receivers 604 can be used to research and investigate subsurface structures of the earth 616. Embodiments of the system 600 may include a plurality of seismic sources arranged in an array.

Accordingly, the one or more seismic receivers 604 can be positioned to receive and record seismic energy data or seismic field records in any form including, but not limited to, a geophysical time series recording of the acoustic reflection and refraction of waveforms that travel from the seismic source array 602 to the one or more seismic receivers 604. Variations in the travel times of reflection and refraction events in one or more field records in seismic data processing can produce seismic data 608 that demonstrates subsurface structures and enables the identification of discontinuities in accordance with the embodiment described in the disclosure. Seismic images produced from the seismic image data may be used to aid in the search for, and exploitation of, subsurface mineral deposits in the geological structure.

Generally speaking, the one or more seismic receivers 604 can record sound wave echoes (otherwise known as seismic energy signal reflections) that come back up through the ground from a seismic source array 602 to a recording surface. Such seismic receivers 604 can record the intensity of such sound waves and the time it took for the sound wave to travel from the seismic source array 602 back to the one or more seismic receivers 604 at the recording surface. According to embodiments of the present disclosure, for example, during the seismic imaging process, the reflections of sound waves emitted by a seismic source array 602, and recorded by a seismic energy recording 604, can be processed by a computer to detect faults in the present in the earth 616. The detected faults and resulting seismic image of the subsurface can be used to identify, for example, the placement of wells and potential well flow paths.

More specifically, the term seismic receiver 604 as is known and understood by those skilled in the art, can include geophones, hydrophones and other sensors designed to receive and record seismic energy. In some embodiments, the seismic receiver 604 may be implemented with distributed acoustic sensing (DAS) using a fiber optic cable. Accordingly, by placing a plurality of geophone seismic receivers 604 at a recording surface, a two-dimensional seismic image can be produced responsive to seismic data recorded by the geophone seismic receivers. Embodiments of the system 600 may include a designated spacing between each receiver of the one or more receivers 604.

According to an embodiment of the present disclosure, the one or more seismic receivers 604 can be positioned to receive and record seismic energy data or seismic field records in any form including a geophysical time series recording of the acoustic reflection and refraction of waveforms that travel from the seismic source array 602 to the one or more seismic receivers 604. Variations in the travel times of reflection and refraction events in one or more field records in a plurality of seismic signals can, when processed by the seismic data processing computer 606, produce seismic data 608 that demonstrates subsurface structure. As described herein, prior to using a seismic data 608 to aid in the search for, and exploitation of, mineral deposits, the seismic data 608 may be processed to construct an uphole-calibrated velocity model from uphole seismic survey data using a machine learning model. The interpretation of the seismic image 612 generated from such data may be used to determine the location of wells drilling into the earth 616. Thus, one or more drills may be drilled into the earth 616 in response to the generation and interpretation of the seismic image 612.

FIG. 7 depicts components of a seismic data processing computer 700 in accordance with an embodiment of the disclosure. In some embodiments, seismic data processing computer 700 may be in communication with other components of a system for obtaining and producing seismic data. Such other components may include, for example, seismic shot stations (sources) and seismic receiving stations (receivers). As shown in FIG. 7, the seismic data processing computer 700 may include a seismic data processor 702, a memory 704, a display 706, and a network interface 708. It should be appreciated that the seismic data processing computer 700 may include other components that are omitted for clarity. In some embodiments, seismic data processing computer 700 may include or be a part of a computer cluster, cloud-computing system, a data center, a server rack or other server enclosure, a server, a virtual server, a desktop computer, a laptop computer, a tablet computer, or the like.

The seismic data processor 702 (as used the disclosure, the term “processor” encompasses microprocessors) may include one or more processors having the capability to receive and process seismic data, such as data received from seismic receiving stations. In some embodiments, the seismic data processor 702 may include an application-specific integrated circuit (AISC). In some embodiments, the seismic data processor 702 may include a reduced instruction set (RISC) processor. Additionally, the seismic data processor 702 may include a single-core processors and multicore processors and may include graphics processors. Multiple processors may be employed to provide for parallel or sequential execution of one or more of the techniques described in the disclosure. The seismic data processor 702 may receive instructions and data from a memory (for example, memory 704).

The memory 704 (which may include one or more tangible non-transitory computer readable storage mediums) may include volatile memory, such as random access memory (RAM), and non-volatile memory, such as ROM, flash memory, a hard drive, any other suitable optical, magnetic, or solid-state storage medium, or a combination thereof. The memory 704 may be accessible by the seismic data processor 702. The memory 704 may store executable computer code. The executable computer code may include computer program instructions for implementing one or more techniques described in the disclosure. For example, the executable computer code may include uphole calibrated velocity instructions 712 that define a uphole calibrated velocity module having a machine learning model to implement embodiments of the present disclosure. In some embodiments, the uphole calibrated velocity instructions 712 may implement one or more elements of process 200 described above and illustrated in FIGS. 2A and 2B. In some embodiments, the uphole calibrated velocity instructions 712 may receive, as input, seismic data 710 and may produce, as output, an identification of faults in the seismic data. In some embodiments, a seismic image 716 may be produced, stored in the memory 704 and, as shown in FIG. 7, displayed on the display 706.

The display 706 may include a cathode ray tube (CRT) display, liquid crystal display (LCD), an organic light emitting diode (OLED) display, or other suitable display. The display 706 may display a user interface (for example, a graphical user interface) that may display information received from the plant information processing computer 706. In accordance with some embodiments, the display 706 may be a touch screen and may include or be provided with touch sensitive elements through which a user may interact with the user interface.

The network interface 708 may provide for communication between the seismic data processing computer 700 and other devices. The network interface 708 may include a wired network interface card (NIC), a wireless (e.g., radio frequency) network interface card, or combination thereof. The network interface 708 may include circuitry for receiving and sending signals to and from communications networks, such as an antenna system, an RF transceiver, an amplifier, a tuner, an oscillator, a digital signal processor, and so forth. The network interface 708 may communicate with networks, such as the Internet, an intranet, a wide area network (WAN), a local area network (LAN), a metropolitan area network (MAN) or other networks. Communication over networks may use suitable standards, protocols, and technologies, such as Ethernet Bluetooth, Wireless Fidelity (Wi-Fi) (e.g., IEEE 802.11 standards), and other standards, protocols, and technologies. In some embodiments, for example, the unprocessed seismic data 7010 may be received over a network via the network interface 708. In some embodiments, for example, the seismic image 716 may be provided to other devices over the network via the network interface 708.

In some embodiments, seismic data processing computer may be coupled to an input device 720 (for example, one or more input devices). The input devices 720 may include, for example, a keyboard, a mouse, a microphone, or other input devices. In some embodiments, the input device 720 may enable interaction with a user interface displayed on the display 706. For example, in some embodiments, the input devices 720 may enable the entry of inputs that control the acquisition of seismic data, the processing of seismic data, and so on.

### Examples

The following examples are included to demonstrate embodiments of the disclosure. It should be appreciated by those of skill in the art that the techniques and compositions disclosed in the example which follows represents techniques and compositions discovered to function well in the practice of the disclosure, and thus can be considered to constitute modes for its practice. However, those of skill in the art should, in light of the present disclosure, appreciate that many changes can be made in the specific embodiments which are disclosed and still obtain a like or a similar result without departing from the spirit and scope of the disclosure.

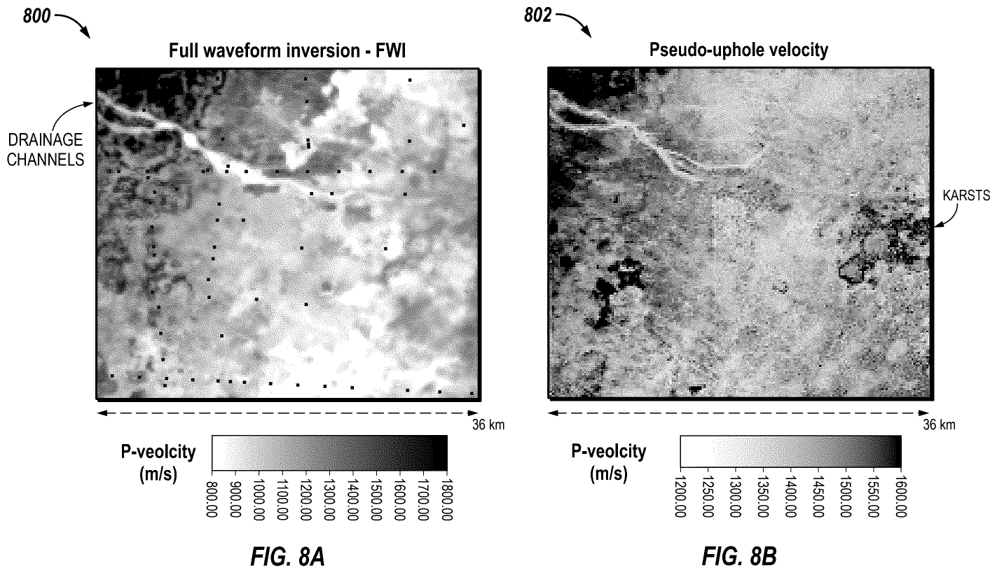

The techniques described in the disclosure were applied to a dataset of 88 vertical upholes and 113400 XY-CMP travel times vs offset sets. The results were compared with an existing, high-resolution velocity model obtained independently using full waveform inversion (FWI). FIGS. 8A and 8B depict velocity (in m/s) depth slices 800 and 802 approximately 40 meters (m) from the surface, with FIG. 8A depicting the results from a full waveform inversion with the location of the upholes identified by blue dots, and FIG. 8B depicting the results with pseudo uphole velocities determined according to an embodiment of the disclosure. FIG. 8 shows that the pseudo-uphole velocity determined according to the techniques of the disclosure reproduces with a higher resolution than the velocities from FWI. These pseudo-uphole velocities are calibrated by direct travel time measurements from the upholes.

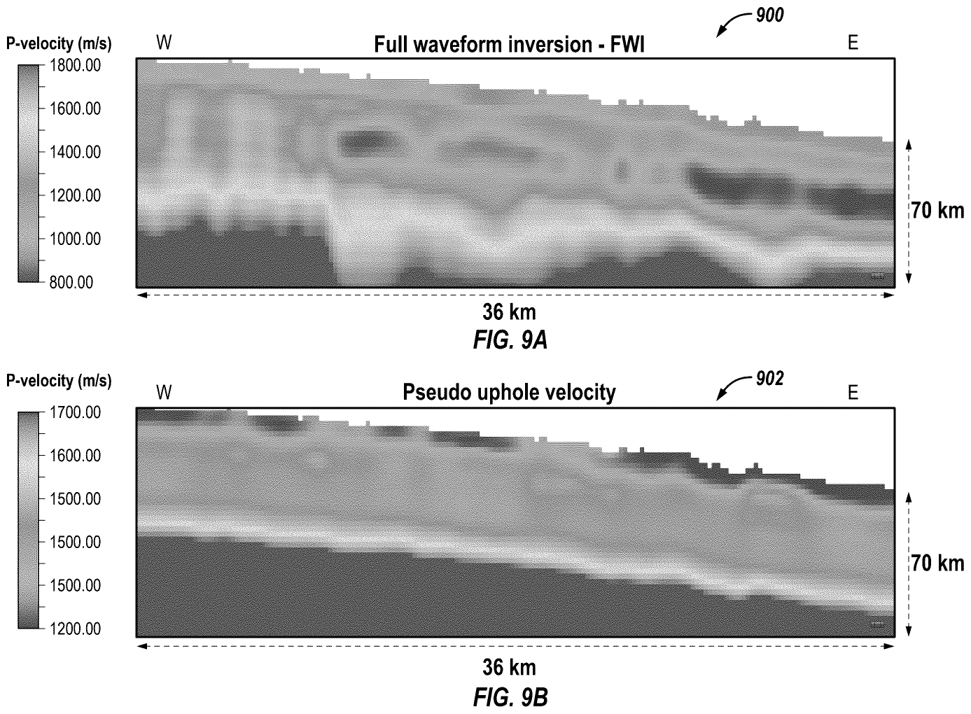

FIGS. 9A and 9B depict E-W velocity (in m/s) cross sections 900 and 902 through the entire volume in accordance with an embodiment of the disclosure. FIG. 9A depicts the velocities determined using a full waveform inversion (FWI), and FIG. 9B depicts the pseudo uphole velocities determined according to the techniques of the disclosure. FIGS. 9A and 9B show that the pseudo-uphole velocity can reproduce the shallow velocity inversion observed from FWI. Moreover, the pseudo-uphole velocity is more laterally continuous and more geology-consistent for the shallow section than the shallow FWI result.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A computer-implemented method for determining uphole velocities of an uphole velocity model for an uphole seismic survey comprising an uphole seismic survey dataset generated from a seismic receiver station configured to sense seismic signals originating from a seismic source station, the method comprising:
obtaining the uphole seismic survey dataset comprising first break travel times;
sorting the first break travel times into offset bins of a travel time attribute cube according to common midpoints for refracted seismic wave travel between the seismic sources and the seismic receiver;
removing anomalous travel times from the sorted travel times in the offset bins to form a refined first break dataset;
forming a travel times vs offset function based on the refined first break dataset;
obtaining uphole times associated with the uphole seismic survey dataset, the uphole times comprising travel times vs depth;
training a supervised machine learning model using training data comprising the travel times vs offset function at a common midpoint (CMP) based on an uphole location, and the uphole times at the uphole location, wherein the uphole times are the labels for the training data;
determining uphole times for the entire uphole seismic survey dataset using the trained machine learning model; and
transforming the determined uphole times to uphole velocities.

2. The method of claim 1, wherein the supervised machine learning model comprises a fully-connected artificial neural network (ANN), a convolutional neural network (CNN) or a multivariate regression model.

3. The method of claim 1, comprising generating a seismic image using the uphole velocities.

4. A non-transitory computer-readable storage medium having executable code stored thereon for determining uphole velocities of an uphole velocity model for an uphole seismic survey comprising an uphole seismic survey dataset generated from a seismic receiver station configured to sense seismic signals originating from a seismic source station, the executable code comprising a set of instructions that causes a processor to perform operations comprising:
obtaining the uphole seismic survey dataset comprising first break travel times;
sorting the first break travel times into offset bins of a travel time attribute cube according to common midpoints for refracted seismic wave travel between the seismic sources and the seismic receiver;
removing anomalous travel times from the sorted travel times in the offset bins to form a refined first break dataset;
forming a travel times vs offset function based on the refined first break dataset;
obtaining uphole times associated with the uphole seismic survey dataset, the uphole times comprising travel times vs depth;
training a supervised machine learning model using training data comprising the travel times vs offset function at a common midpoint (CMP) based on an uphole location, and the uphole times at the uphole location, wherein the uphole times are the labels for the training data;
determining uphole times for the uphole seismic survey dataset using the trained machine learning model; and
transforming the determined uphole times to uphole velocities.

5. The non-transitory computer-readable storage medium of claim 4, wherein the supervised machine learning model comprises a fully-connected artificial neural network (ANN), a convolutional neural network (CNN) or a multivariate regression model.

6. The non-transitory computer-readable storage medium of claim 4, comprising generating a seismic image using the uphole velocities.

7. A system, comprising:
a seismic source station;
a seismic receiver station configured to sense seismic signals originating from a seismic source station;
a seismic data processor;
a non-transitory computer-readable storage memory accessible by the seismic data processor and having executable code stored thereon for determining uphole velocities of an uphole velocity model for an uphole seismic survey comprising an uphole seismic survey dataset from the seismic signals, the executable code comprising a set of instructions that causes the seismic data processor to perform operations comprising:
obtaining the uphole seismic survey dataset comprising first break travel times;
sorting the first break travel times into offset bins of a travel time attribute cube according to common midpoints for refracted seismic wave travel between the seismic sources and the seismic receiver;
removing anomalous travel times from the sorted travel times in the offset bins to form a refined first break dataset;
forming a travel times vs offset function based on the refined first break dataset;
obtaining uphole times associated with the uphole seismic survey dataset, the uphole times comprising travel times vs depth;
training a supervised machine learning model using training data comprising the travel times vs offset function at a common midpoint (CMP) based on an uphole location, and the uphole times at the uphole location, wherein the uphole times are the labels for the training data; and
determining uphole times for the entire uphole seismic survey dataset using the trained machine learning model; and
transforming the determined uphole times to uphole velocities.

8. The system of claim 7, wherein the supervised machine learning model comprises a fully-connected artificial neural network (ANN), a convolutional neural network (CNN) or a multivariate regression model.

9. The system of claim 7, comprising generating a seismic image using the uphole velocities.

10. A computer-implemented method for determining uphole velocities of an uphole velocity model for an uphole seismic survey comprising an uphole seismic survey dataset generated from a seismic receiver station configured to sense seismic signals originating from a seismic source station, the method comprising:
obtaining the uphole seismic survey dataset comprising first break travel times;
sorting the first break travel times into offset bins of a travel time attribute cube according to common midpoints for refracted seismic wave travel between the seismic sources and the seismic receiver;
removing anomalous travel times from the sorted travel times in the offset bins to form a refined first break dataset;
forming a travel times vs offset function based on the refined first break dataset;
obtaining uphole velocities associated with the uphole seismic survey dataset, the uphole velocities comprising interval velocity vs. depth;
training a supervised machine learning model using training data comprising the travel times vs offset function at a common midpoint (CMP) based on an uphole location and uphole velocities at the uphole location, wherein the uphole velocities are the labels for the training data; and
determining uphole velocities for the uphole seismic survey dataset using the trained machine learning model.

11. The method of claim 10, wherein the supervised machine learning model comprises a fully-connected artificial neural network (ANN), a convolutional neural network (CNN) or a multivariate regression model.

12. The method of claim 10, comprising generating a seismic image using the uphole velocities.

13. A non-transitory computer-readable storage medium having executable code stored thereon for determining uphole velocities of an uphole velocity model for an uphole seismic survey comprising an uphole seismic survey dataset generated from a seismic receiver station configured to sense seismic signals originating from a seismic source station, the executable code comprising a set of instructions that causes a processor to perform operations comprising:
obtaining an uphole seismic survey dataset comprising first break travel times;
sorting the first break travel times into offset bins of a travel time attribute cube according to common midpoints for refracted seismic wave travel between the seismic sources and the seismic receiver;
removing anomalous travel times from the sorted travel times in the offset bins to form a refined first break dataset;
forming a travel times vs offset function based on the refined first break dataset;
obtaining uphole velocities associated with the uphole seismic survey dataset, the uphole velocities comprising interval velocity vs. depth;
training a supervised machine learning model using training data comprising the travel times vs offset function at a common midpoint (CMP) based on an uphole location and uphole velocities at the uphole location, wherein the uphole velocities are the labels for the training data; and
determining uphole velocities for the uphole seismic survey dataset using the trained machine learning model.

14. The non-transitory computer-readable storage medium of claim 13, wherein the supervised machine learning model comprises a fully-connected artificial neural network (ANN), a convolutional neural network (CNN) or a multivariate regression model.

15. The non-transitory computer-readable storage medium of claim 13, comprising generating a seismic image using the uphole velocities.

16. A system, comprising:
a seismic source station;
a seismic receiver station configured to sense seismic signals originating from a seismic source station;
a seismic data processor;
non-transitory computer-readable storage memory accessible by the seismic data processor and having executable code stored thereon for determining uphole velocities of an uphole velocity model for an uphole seismic survey comprising an uphole seismic survey dataset from the seismic signals, the executable code comprising a set of instructions that causes the seismic data processor to perform operations comprising:
obtaining the uphole seismic survey dataset comprising first break travel times;
sorting the first break travel times into offset bins of a travel time attribute cube according to common midpoints for refracted seismic wave travel between the seismic sources and the seismic receiver;
removing anomalous travel times from the sorted travel times in the offset bins to form a refined first break dataset;
forming a travel times vs offset function based on the refined first break dataset;
obtaining uphole velocities associated with the uphole seismic survey dataset, the uphole velocities comprising interval velocity vs. depth;
training a supervised machine learning model using training data comprising the travel times vs offset function at a common midpoint (CMP) based on an uphole location and uphole velocities at the uphole location, wherein the uphole velocities are the labels for the training data; and
determining uphole velocities for the uphole seismic survey dataset using the trained machine learning model.

17. The system of claim 16, wherein the supervised machine learning model comprises a fully-connected artificial neural network (ANN), a convolutional neural network (CNN) or a multivariate regression model.

18. The system of claim 16, The method of claim 1, comprising generating a seismic image using the uphole velocities.

19. A computer-implemented method for determining uphole velocities of an uphole velocity model for an uphole seismic survey comprising an uphole seismic survey dataset generated from a seismic receiver station configured to sense seismic signals originating from a seismic source station, the method comprising:
obtaining the uphole seismic survey dataset comprising first break travel times;
sorting the first break travel times into offset bins of a travel time attribute cube according to common midpoints for refracted seismic wave travel between the seismic sources and the seismic receiver;
removing anomalous travel times from the sorted travel times in the offset bins to form a refined first break dataset;
forming a travel times vs offset function based on the refined first break dataset;
inverting the travel-times vs offset function to obtain a velocity model for first break waves, wherein the velocity model comprises seismic velocities vs. depth;
obtaining uphole velocities associated with the uphole seismic survey dataset, the uphole velocities comprising interval velocity vs. depth;
training a supervised machine learning model using training data comprising the seismic velocities vs. depth at an uphole location and the uphole velocities at the uphole location, wherein the uphole velocities are the labels for the training data; and
determining uphole velocities for the uphole seismic survey dataset using the trained machine learning model.

20. The method of claim 19, wherein the supervised machine learning model comprises a fully-connected artificial neural network (ANN), a convolutional neural network (CNN) or a multivariate regression model.

21. The method of claim 19, The method of claim 1, comprising generating a seismic image using the uphole velocities.

22. A non-transitory computer-readable storage medium having executable code stored thereon for determining uphole velocities of an uphole velocity model for an uphole seismic survey comprising an uphole seismic survey dataset generated from a seismic receiver station configured to sense seismic signals originating from a seismic source station, the executable code comprising a set of instructions that causes a processor to perform operations comprising:
obtaining an uphole seismic survey dataset comprising first break travel times;
sorting the first break travel times into offset bins of a travel time attribute cube according to common midpoints for refracted seismic wave travel between the seismic sources and the seismic receiver;
removing anomalous travel times from the sorted travel times in the offset bins to form a refined first break dataset;
forming a travel times vs offset function based on the refined first break dataset;
inverting the travel-times vs offset function to obtain a velocity model for first break waves, wherein the velocity model comprises seismic velocities vs. depth;
obtaining uphole velocities associated with the uphole seismic survey dataset, the uphole velocities comprising interval velocity vs. depth;
training a supervised machine learning model using training data comprising the seismic velocities vs. depth at an uphole location and the uphole velocities at the uphole location, wherein the uphole velocities are the labels for the training data; and
determining uphole velocities for the uphole seismic survey dataset using the trained machine learning model.

23. The non-transitory computer-readable storage medium of claim 22, wherein the supervised machine learning model comprises a fully-connected artificial neural network (ANN), a convolutional neural network (CNN) or a multivariate regression model.

24. The non-transitory computer-readable storage medium of claim 22, comprising generating a seismic image using the uphole velocities.

25. A system, comprising:
a seismic source station;
a seismic receiver station configured to sense seismic signals originating from a seismic source station;
a seismic data processor;
non-transitory computer-readable storage memory accessible by the seismic data processor and having executable code stored thereon for determining uphole velocities of an uphole velocity model for an uphole seismic survey comprising an uphole seismic survey dataset from the seismic signals, the executable code comprising a set of instructions that causes the seismic data processor to perform operations comprising:
obtaining an uphole seismic survey dataset comprising first break travel times;
sorting the first break travel times into offset bins of a travel time attribute cube according to common midpoints for refracted seismic wave travel between the seismic sources and the seismic receiver;
removing anomalous travel times from the sorted travel times in the offset bins to form a refined first break dataset;
forming a travel times vs offset function based on the refined first break dataset;
inverting the travel-times vs offset function to obtain a velocity model for first break waves, wherein the velocity model comprises seismic velocities vs. depth;
obtaining uphole velocities associated with the uphole seismic survey dataset, the uphole velocities comprising interval velocity vs. depth;
training a supervised machine learning model using training data comprising the seismic velocities vs. depth at an uphole location and the uphole velocities at the uphole location, wherein the uphole velocities are the labels for the training data; and
determining uphole velocities for the uphole seismic survey dataset using the trained machine learning model.

26. The system of claim 25, wherein the supervised machine learning model comprises a fully-connected artificial neural network (ANN), a convolutional neural network (CNN) or a multivariate regression model.

27. The system of claim 25, comprising generating a seismic image using the uphole velocities.
